(19) United States
(12) Patent Application Publication
(10) Pub. No.: US 2012/0305727 A1
(43) Pub. Date: Dec. 6, 2012

(54) Quick Release Mechanism For Hanging Projector Mount with Safety Features

(75) Inventor: Michael F. Bouissiere, Yorba Linda, CA (US)

(73) Assignee: Premier Mounts, Inc., Anaheim, CA (US)

(21) Appl. No.: 13/152,490

(22) Filed: Jun. 3, 2011

(51) Int. Cl. F16M 13/00; B23P 11/00

(52) U.S. Cl. 248/309.1; 29/426.1

(57) ABSTRACT

A safety feature for a spindle swivel has a cylindrical portion that fits inside a spindle receiver. The spindle swivel and spindle receiver have a wavy interface between them that ensures at least one preferred azimuthal orientation between them when they are forced together. A twist lock collar is pivotally attached to the spindle receiver, and may be rotated by a user around a central axis, against the action of a torsion spring, from a locked position to an unlocked position. In the locked position, various ramps inside the twist lock collar force respective steel balls radially inward through respective holes in the spindle receiver to engage respective notches in the cylindrical portion of the spindle swivel. In the unlocked position, the ramps decrease the radial inward force on the steel balls, disengaging them from the notches, and the spindle swivel may be separated from the spindle receiver by the user. The safety feature unlocks only some of the balls from their recesses. The remaining balls are forced thru a channel which prevents direct removal of the spindle without rotation thereof, preventing accidental unexpected disengagement.

### BACKGROUND

1. Technical Field

The present invention is directed to a quick release mechanism for a hanging a device, most likely a projector.

2. Description of the Related Art

There is a long history of using projectors in conference rooms and classrooms. As far back as the 1950s, filmstrip and slide projectors were used to project images on a screen or a wall. Back then, the projectors rested on a flat surface, such as a table, counter and shelf. For some elaborate setups, the projector rested on a dedicated cart that could be wheeled around as needed.

Back then, it was relatively easy to access the projector, to replace a bulb or perform some other maintenance. However, there were some disadvantages to simply resting the projector on a flat surface. For instance, the surface could be bumped, causing the projector to vibrate and causing a disruption in the image. In addition, because the projector was typically just above the level of the audience members' heads, the image would show silhouette of any audience members getting up to leave or arriving and sitting down.

In recent times, it has become more common for projectors to be mounted in conference rooms and classrooms, typically in a hanging manner from a mount that attaches to the ceiling. Many of these mounts are strong and semi-permanent, with the mount being screwed into the ceiling and the projector being screwed into the mount.

These semi-permanent mounts are a significant improvement over simply resting the projector on a flat surface. For instance, because the mount is strong, it is relatively insensitive to vibrations caused by bumping a table or desk or other movement in the room. In addition, because the projector is mounted near the ceiling and is well above the heads of the audience, visual disruptions and shadowing caused by the audience may be reduced.

However, there are still disadvantages to the hanging semi-permanent mounts. For instance, because many of these mounts emphasize strength and stability, they are not conducive to maintenance of the projector. Consider the effort that may be required to replace a projector bulb for one of these mounts. The projector may be mounted in an awkward position, such as upside down, and may be well off the floor, so that replacing a bulb may require removing the projector from the mount. The mount may require tools to remove the projector, such as a screwdriver or, worse, tools that are specific to the particular mount. More problematic, once the maintenance has been performed on the projector, it may be difficult to reattach the projector to the mount. The reattachment may even require an extra person, if extra tools are required. In addition, even if the projector is reattached to the mount, it is likely that the projector has moved slightly from its original position, due to the imprecision of such a mount and the awkwardness of reattaching it.

Finally, once a projector is attached and mounted, its removable can be challenging because, once the projector is released, there is a chance that it will quickly drop and if the installer is not prepared, it could hit the floor.

Accordingly, there exists a need for a hanging projector mount that is easily detachable and re-attachable, and is strong and secure enough to support a projector and has a safety feature which can prevent accidental dropping if the user is not prepared to received the detached unit.

### BRIEF SUMMARY

The disclosure encompasses many embodiments. One such embodiment is detailed below in summary fashion. Please understand that this summary does not encompass the entire disclosure but is provided to assist the reader in reviewing the entire disclosure and claims which also constitute part of the disclosure.

A quick release mechanism (1) for a hanging a device such as projector mount, having a spindle swivel (2) comprising: a generally cylindrical male mating surface (21) having a male mating surface outer diameter and including a plurality of spindle swivel notches/recesses/depressions (22); an outer portion (23) longitudinally adjacent to the male mating surface (21) and having an outer diameter that is larger than the male mating surface outer diameter; and a longitudinally wavy spindle swivel interface (24) between the male mating surface (21) and the outer portion (23); a spindle receiver (3) for receiving the spindle swivel (2), the spindle receiver (3) comprising: a generally cylindrical female mating surface (31) sized to accommodate the male mating surface (21) and including a plurality of spindle receiver holes (32); and a longitudinally wavy spindle receiver interface (34) that complements the longitudinally wavy spindle swivel interface (24) and defines a plurality of lockable orientations between the spindle receiver (3) and the spindle swivel (2); wherein when the spindle swivel (2) is fully inserted into the spindle receiver (3) at one of the lockable orientations, the spindle receiver holes (32) are aligned with the spindle swivel notches (22); a pin (4) attached to the spindle receiver (3) and extending generally radially outward through the female mating surface (31); a plurality of balls (5) sized smaller than the spindle receiver holes (32) for engaging the spindle swivel notches (22); a twist lock collar (6) pivotally attached to the spindle receiver (3) and azimuthally (circumferentially) rotatable from a locked position to an unlocked position, the twist lock collar (6) having a twist lock collar inner surface (61) comprising: a plurality of ramps (62) for engaging the balls (5), wherein when the spindle swivel (2) is fully inserted into the spindle receiver (3) at one of the lockable orientations and the twist lock collar (6) is in the locked position, the ramps (62) securely engage the balls (5) into the spindle swivel notches (22), and wherein when the spindle swivel (2) is fully inserted into the spindle receiver (3) at one of the lockable orientations and the twist lock collar (6) is in the unlocked position, the ramps (62) disengage the balls (5) from the spindle swivel notches (22); and a plurality of angled teeth (63) for engaging the pin (4) which controls essentially a switching mechanism, the teeth (63) angled to allow rotation of the twist lock collar (6) from the locked position to the unlocked position and to prevent rotation of the twist lock collar (6) from the unlocked position to the locked position; and a torsion spring (7) for forcing the twist lock collar (6) from the unlocked position to the locked position, the torsion spring (7) having a proximal end (71) attached to the twist lock collar (6) and a distal end (72) opposite the proximal end (71) attached to the spindle receiver (3).

In addition, there is disclosed an improvement in a quick release mechanism (1) for a hanging projector mount, having a spindle (2) having a generally cylindrical male mating surface (21) having outer diameter and including a plurality of spindle recesses (22) and a distal peripheral edge; a spindle receiver (3) for receiving the spindle (2), the spindle receiver (3) comprising: a generally cylindrical female mating surface (31) sized to accommodate the male mating surface (21) and including a plurality of spindle receiver holes (32); and wherein when the spindle (2) is fully inserted into the spindle receiver (3), the spindle receiver holes (32) are aligned with the spindle recesses (22); a plurality of balls (5) sized smaller than the spindle receiver holes (32) for engaging the spindle swivel recesses (22); the safety feature improvement comprises a lock (6) pivotally attached to the spindle receiver (3) and rotatable from a locked position to an unlocked position, having a collar, which causes some, but not all, of the balls to disengage from said recesses, said remaining balls remaining non-retracted from said recesses; a channel connected to and leading from said recesses which have non-retractable balls engaged therein, said channel running from said recesses to said distal peripheral edge of the spindle thereby creating a path for said non-retracted balls follow to achieve complete disengagement of the spindle from said spindle receiver.

The improvement further includes a landing recess directly adjacent thereto, said stop recess including a radiussed upper portion to receive a portion of the ball.

The improvement further includes a channel which abuts said stop recess below said radiused portion.

The improvement further includes a helical channel portion.

The improvement further includes a landing zone between the peripheral edge and the recess.

The improvement further includes a channel including a helical portion connected to said landing recess at a proximal end and a generally flat portion extending from a distal portion of said channel.

Further disclosed is a safety feature on a twist release mechanism having a spindle with a distal peripheral edge, a spindle receiver sized to receive said spindle, at least one retractable projection in said receiver and at least one non-retractable projections in said spindle receiver, said projections being receivable into recesses in said receiver, said retractable projects being retractable in response to a release mechanism; the safety feature which comprises, a channel connected to and leading from said recesses associated with said at least one non-retractable projection, said channel running from said recesses to said distal peripheral edge of the spindle thereby creating a path for said non-retracted balls follow to achieve complete disengagement of the spindle from said spindle receiver, said channel following a generally helical path to said distal edge and including a landing zone region which is generally flat where said projections have no turning moment.

Also disclosed is a method of preventing accidental removal of a two part cylindrical coupling being held together by engagement of projections in one part projecting into recesses in the other part, at least some of the recesses being in communication with channels extending to a distal edge of part on which the channels are located, comprising the steps of: releasing at least some, but not all of the projections from their recesses to allow limited but not complete separation, maintaining the two parts engaged while projections engaged a portion of the channel, twisting the two portions relative to each other to move the projections in the recesses along the channel continuing the rotations along a channel until the projections reach the peripheral edge and thus complete separation of the parts.

### BRIEF DESCRIPTION OF THE SEVERAL VIEWS OF THE DRAWINGS

FIG. 1 is an exploded drawing of a quick release mechanism, viewed from above.

FIG. 2 is an exploded drawing of the quick release mechanism, viewed from below.

FIG. 3 is a cutaway drawing of the assembled quick release mechanism 1 of FIGS. 1 and 2.

FIG. 4 is a cutaway drawing of the assembled quick release mechanism 1 of FIGS. 1 and 2.

FIG. 5 is a cutaway drawing of the assembled quick release mechanism 1 of FIGS. 1 and 2.

FIG. 6 is a cutaway drawing of the assembled quick release mechanism 1 of FIGS. 1 and 2.

FIG. 7 is an environmental plan drawing of the quick release mechanism of FIGS. 1 through 6, with a ceiling bracket, a projector bracket and a projector.

FIG. 8 is a top plan view.

FIG. 9 is a side view taken along lines A-A of FIG. 8.

FIG. 10 is a perspective view of an alternative version of the spindle swivel with safety feature.

FIG. 11a is a top plan view of the spindle of FIG. 10.

FIG. 11b is a side plan view of the spindle of FIG. 10.

FIG. 11c is a side plan view of the spindle of FIG. 10.

FIG. 11d is a side plan view of the spindle of FIG. 10.

FIG. 11e is a sectional view along lines B-B of the spindle of FIG. 11d.

FIG. 11f is a sectional view along lines A-A of the spindle of FIG. 11c.

FIG. 11g is a view like FIG. 11c except the other side.

FIG. 12a is a top plan view of the spindle receiver 3 designed to mate with the spindle of FIG. 11a-f.

FIG. 12b is a side plan view of the spindle receiver of FIG. 12a.

FIG. 12c is a sectional view along lines A-A of FIG. 12b.

FIG. 12d is a sectional view along lines B-B of FIG. 12a.

FIG. 12e is a sectional view along lines C-C of FIG. 12a.

### DETAILED DESCRIPTION

A quick release mechanism for a hanging projector mount is disclosed, which during use is disposed between the projector 100 and the ceiling. A spindle swivel has a cylindrical portion that fits inside a spindle receiver. The spindle swivel and spindle receiver have a wavy interface between them that ensures at least one preferred azimuthal (circumferential) orientation between them when they are forced together. A twist lock collar is pivotally attached to the spindle receiver, and may be rotated by a user around a central axis, against the action of a torsion spring, from a locked position to an unlocked position. In the locked position, various ramps inside the twist lock collar force respective steel balls radially inward through respective holes in the spindle receiver to engage respective notches in the cylindrical portion of the spindle swivel. In the unlocked position, the ramps decrease the radial inward force on the steel balls, disengaging them from the notches, and the spindle swivel may be separated from the spindle receiver by the user. Once separated, the twist lock collar remains in the unlocked position, due to the engagement of a steel pin in a series of angled teeth on the inside of the twist lock collar. When the spindle swivel is reinserted, the cylindrical portion detaches the steel pin from the teeth, and the torsion spring forces the twist lock collar back to the locked position.

The preceding paragraph is merely an overview of the quick release mechanism. A more detailed discussion follows.

FIG. 7 is a plan drawing of a quick release mechanism 1, which is located between a projector and the ceiling. In this particular drawing, the projector system is viewed from above, as if the viewer were within the ceiling.

The projector mounting system contains additional brackets for fastening to the projector 100 and to the ceiling, with the ceiling bracket 102 attaching to the spindle receiver 104 and the twist lock collar 106, and the projector bracket 108 attaching to the spindle swivel. In other embodiments, the orientation may be reversed, with the projector bracket attaching to the spindle receiver and the twist lock collar, and the ceiling bracket attaching to the spindle swivel. The brackets themselves are constructed and used in a known manner, with various pieces being attached to each other by screws, bolts, friction fit, or other threaded fasteners. In the remainder of this application, we concentrate mainly on the quick release mechanism 1 in the mounting system.

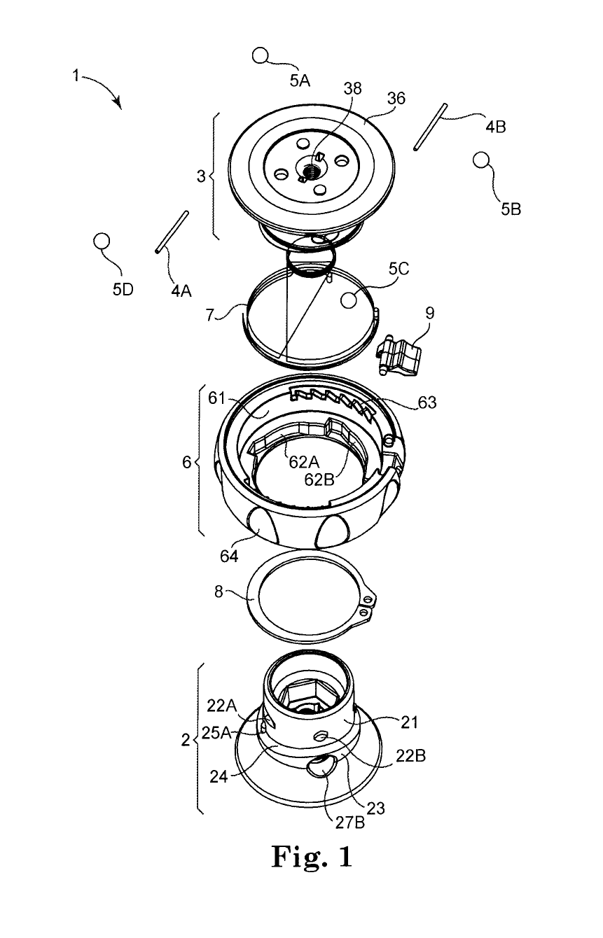

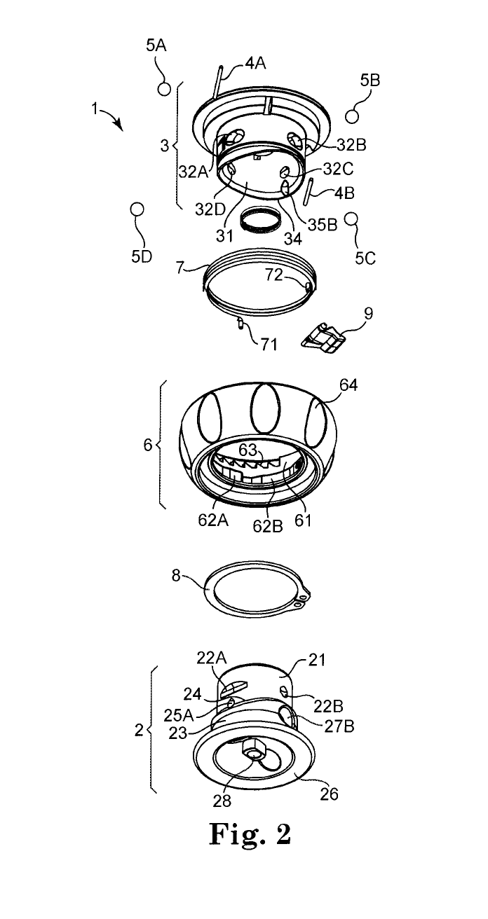

FIGS. 1 and 2 are exploded views of the quick release mechanism 1 of FIG. 7, as viewed from above and below, respectively.

When assembled, the lowermost element, referred to as a “spindle swivel” 2, is attached to the projector bracket in a semi-permanent manner; it may be unscrewed from the projector if desired, but it is generally attached with the intent of remaining attached for multiple attach/release cycles of the quick release mechanism 1. Everything except the spindle swivel 2 is attached to the ceiling bracket, also in an analogous semi-permanent manner. We first describe the spindle swivel 2, then progress upwards in FIGS. 1 and 2 to describe the remaining elements.

The spindle swivel 2 is attachable to projector bracket on its lowermost face 26, which may include a generally flat ring around its circumference as well as various indentations and/or screw holes. In the specific example shown in FIGS. 1 and 2, there is a central, unthreaded screw hole 28, surrounded by two indentations, although other configurations may be used.

Farthest away from its lowermost face 26 is a generally cylindrical male mating surface 21, which has a particular outer diameter. In the specific example shown in FIGS. 1 and 2, the outer diameter of the cylindrical male mating surface 21 is 1 7/16 inches (36.5 mm), although other values may be used. The cylindrical male mating surface 21 may have a relatively flat edge, farthest from the lowermost face 26, although other shapes may be used.

The cylindrical male mating surface 21 may include one or more notches 22A and 22B, which may be referred to generally as “spindle swivel notches” 22. In the specific example shown in FIGS. 1 and 2, there are two generally round dimples (including 22B) and two generally straight grooves (including 22A), although other configurations may be used. In some embodiments, all the spindle swivel notches 22 are coplanar.

Adjacent to the cylindrical male mating surface 21 is an outer portion 23, which has a larger diameter than that of the cylindrical male mating surface 21. There is an interface between the outer portion 23 and the cylindrical male mating surface 21, which may have a longitudinal periodicity to it. This interface may be referred to generally as a “longitudinally wavy spindle swivel interface” 24, meaning that along the interface, some portions are farther away from the lowermost face 26 than other portions, and the transitions are generally gradual, rather than sharp. In the specific example shown in FIGS. 1 and 2, there are two “peaks” and two “valleys” along the interface 24, although other configurations may be used.

On the cylindrical male mating surface 21, adjacent to the wavy interface 24, there may be one more optional longitudinal locating ridges 25A. The ridges 25 align with corresponding notches on other parts of the quick release mechanism 1, and aid in locating the desired alignment orientation, as well as strengthening the interface between the parts. In the specific example shown in FIGS. 1 and 2, there are two ridges 25A, both being located in the “valleys” along the interface 24, although other configurations may be used.

There may be other features inside the wall of the cylindrical male mating surface 21, which may accommodate the heads of various threaded fasteners. In the specific example shown in FIGS. 1 and 2, the head sizes increase in a stepwise fashion from a square, to circular overlapping with square, to hexagonal, although other configurations may be used.

There also may be one or more threaded holes 27B leading from the exterior of the spindle swivel 2 to the interior. These threaded holes 27B may be used for set screws that hold other fasteners or other parts in place. These set screws may be used in the semi-permanent manner described above.

Elements 3, 4, 5, 6, 7, 8 and 9 are grouped together during use; they are typically assembled at the factory, and remain grouped as a single unit during use by a user. Various elements of 3-9 may move with respect to the other elements, but none is typically removable from the others. During use, all are attached to the ceiling bracket in a semi-permanent manner, as described above. We describe elements 3-9 beginning with element 3, at the top of FIGS. 1 and 2, and progress downward.

Element 3, referred to as a “spindle receiver”, is the part that actually attaches to the spindle swivel 2, with all the other parts cooperating to hold the spindle receiver 3 and spindle swivel 2 together in a strong, reliable, easy-to-use detachable and re-attachable manner.

The spindle receiver 3 attaches to the ceiling bracket on its uppermost face 36 and/or through a threaded screw hole 38. The uppermost face may include one or more optional orienting features that can mate with the ceiling bracket.

The spindle receiver 3 includes a generally cylindrical female mating surface 31 that may lie adjacent to the male mating surface 21 of the spindle swivel 2 during use. The fit between the mating surfaces 21 and 31 is loose enough to ensure that the spindle swivel 2 and spindle receiver 3 are removed easily in the unlocked mode. An extremely tight friction fit between the mating surfaces 21 and 31 is not required, because the surfaces themselves do not actually lock together during use; other features provide the lock.

The female mating surface 31 has one or more “spindle receiver holes” 32 in it, which may extend all the way through the spindle receiver 3. The spindle receiver holes 32 may coincide with the spindle swivel notches 22 on the male mating surface 21 of the spindle swivel 2 when the spindle swivel 2 and spindle receiver 3 are locked together. In the specific example shown in FIGS. 1 and 2, there are four circular spindle receiver holes 32A, 32B, 32C and 32D, all located in the same plane and azimuthally (circumferentially) separated from each other by 90 degrees apart, although other configurations may be used.

A longitudinal edge of the female mating surface 31 may include a so-called “longitudinally wavy spindle receiver interface” 34. This interface 34 is the complement of interface 24, so that when the spindle swivel 2 and spindle receiver 3 are locked together, the interfaces 24 and 34 are in contact with each other, typically along the entire interfaces 24 and 34.

As the swivel 2 and receiver 3 are forced against each other and rotated azimuthally with respect to each other, there are one or more orientations where the interfaces 24 and 34 are in contact with each other along the entire interfaces. These are referred to as “lockable orientations” between the spindle swivel 2 and the spindle receiver 3. At orientations other than the lockable orientations, the wavy interfaces are in contact only at a limited number of points. During use, a user may easily bring the swivel 2 and receiver 3 together, and rotate one or both of them azimuthally until a lockable orientation is found. In the specific example shown in FIGS. 1 and 2, there are two lockable orientations, oriented azimuthally 180 degrees apart, although other numbers of lockable orientations may also be used.

To assist the user in finding a lockable orientation, the female mating surface 31 may include one or more optional longitudinal locating grooves 35B. The grooves 35 accommodate corresponding ridges 25 in the locking orientations, so that the swivel 2 and receiver 3 may slide longitudinally in the locked orientation, and for certain groove/ridge locations, may remain separated at least by the length of the ridge 25 when not in the locking orientation. In the specific example shown in FIGS. 1 and 2, there are two grooves, with only groove 35B being visible in the figures, although other configurations may be used.

The spindle swivel 2 and spindle receiver 3 may be forced together in a lockable orientation, i.e., when the interfaces 24 and 34 are fully in contact, and the locking mechanisms may be applied by the remaining elements attached to the spindle receiver 3.

The largest of these remaining elements is a so-called “twist lock collar” 6. The exterior of the twist lock collar 6 may have ridges 64, knurls or other grippable features for a user, who azimuthally rotates the twist lock collar 64 to attach and/or detach the projector. The interior surface 61 of the twist lock collar 6 includes several features, described below.

The interior surface 61 includes one or more ramps 62, each of which has a radial position that changes with azimuthal position. In general terms, the ramps 62 may “spiral in” or “spiral out” from the center of the interior surface although preferably no ramps extend fully into the center. Each ramp 62 cooperates with a respective ball 5 and forces the ball 5 through a respective spindle receiver hole 32. The ball 5 is smaller than the hole 32. In the locked position, the ramp 62 forces the ball 5 into locking contact with a respective swivel notch 22 in the spindle swivel 2. In the unlocked position, the ramp 62 releases the ball 5 somewhat, disengaging the swivel notch 22 and allowing the spindle swivel 2 to be removed from the spindle receiver 3. The number of ramps 62, balls 5, spindle receiver holes 32 and spindle swivel notches 22 may be typically equal. In the specific example shown in FIGS. 1 and 2, there are four ramps (62A, 62, and two others not visible in the figures), four balls (5A, 5B, 5C and 5D), four spindle receiver holes (32A, 32B, 32C and 32D), and four spindle swivel notches (22A, 22B, and two others not visible in the figures), although other configurations may be used.

The ball 5 may be made of steel, although any suitable material with adequate shear resistance may be used. In the specific example shown in FIGS. 1 and 2, the ball may have a diameter of ¼ inch (6.35 mm), although other sizes may be used.

The interior surface 61 also includes one more series of angled teeth 63. The teeth 63 may engage one or more pins 4, and are angled to allow rotation of the twist lock collar 6 from the locked position to the unlocked position and to prevent rotation of the twist lock collar 6 from the unlocked position to the locked position. The pins 4 work in combination with a torsion spring 7 for forcing the twist lock collar from the unlocked position to the locked position. The torsion spring 7 has a proximal end 71 attached to the twist lock collar 6 and a distal end 72 opposite the proximal end 71 attached to the spindle receiver 3.

The pin 4, or “pin dowel”, may be made of stainless steel, although other materials may be used. In the specific example shown in FIGS. 1 and 2, there are two pins 4A and 4B, each having a length of 0.7 inches (17.78 mm) and an outer diameter of 0.066 inches (1.67 mm), although other numbers and sizes may be used. Each pin may be mounted generally radially and may extend generally radially outward through or into the female mating surface 31.

In the specific example shown in FIGS. 1 and 2, the pin 4 and teeth 63 operate as follows.

When the twist lock collar 6 is in the locked position, rotating the twist lock collar 6 against the action of the torsion spring 7 forces the twist lock collar 6 to the unlocked position.

When the twist lock collar 6 is in the unlocked position and the spindle swivel 2 is fully inserted into the spindle receiver 3 at one of the lockable orientations, forcing together the spindle swivel 2 and the spindle receiver 3 disengages the pin 4 from the angled teeth 63 and forces the twist lock collar 6 to the locked position under the action of the torsion spring 7.

When the twist lock collar 6 is in the unlocked position and the spindle swivel 2 is fully inserted into the spindle receiver 3 at one of the lockable orientations, pulling apart the spindle swivel 2 and the spindle receiver 3 engages the pin 4 in the angled teeth 63, which resists the action of the torsion spring 7 and keeps the twist lock collar 6 in the unlocked position.

The quick release mechanism 1 may include an optional safety release tab 9, which may accessible from the exterior of the twist lock collar 6, and may prevent rotation of the twist lock collar 6 from the locked position to the unlocked position unless the tab is in a particular position.

The quick release mechanism may also include a retaining ring 8 that may help secure many of the elements to the twist lock collar 6.

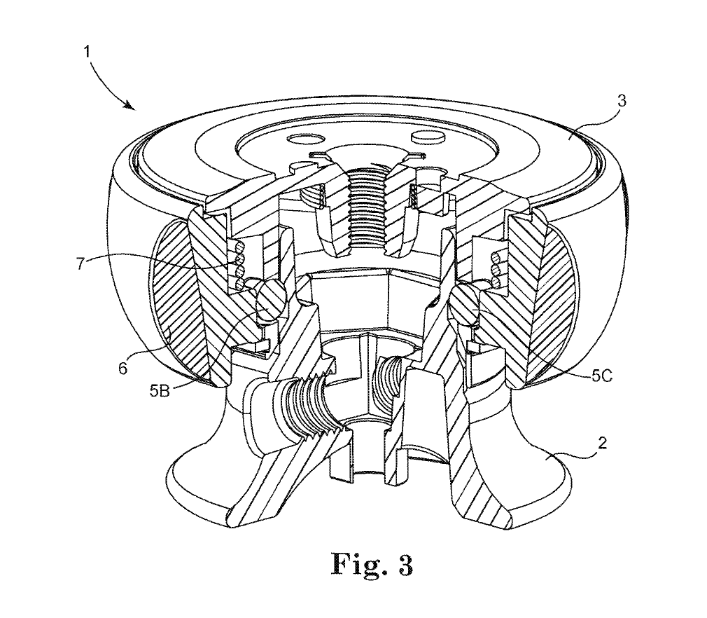

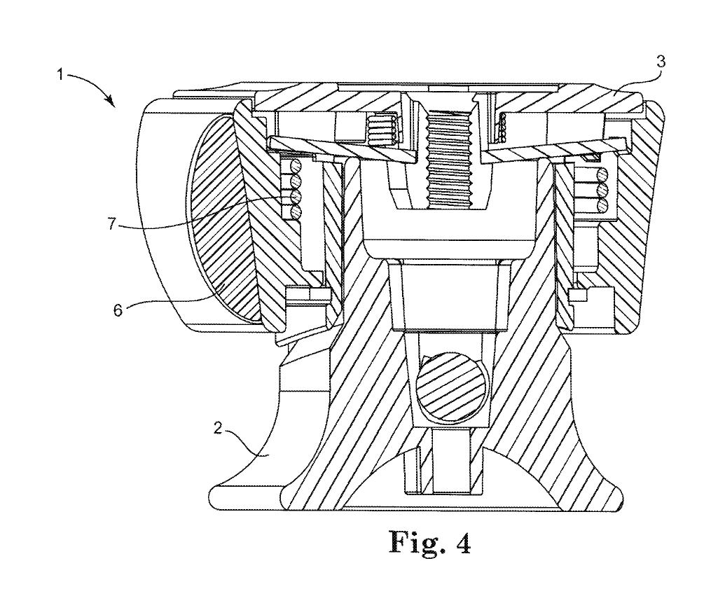

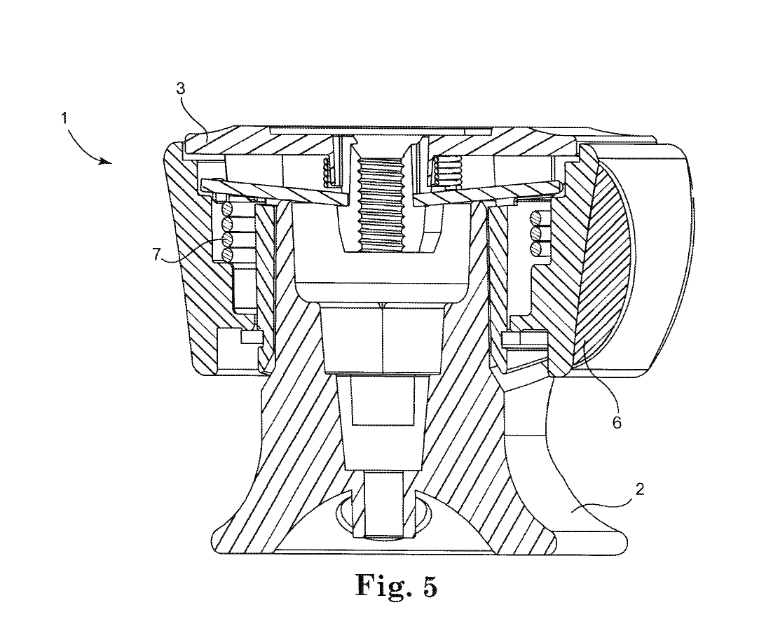

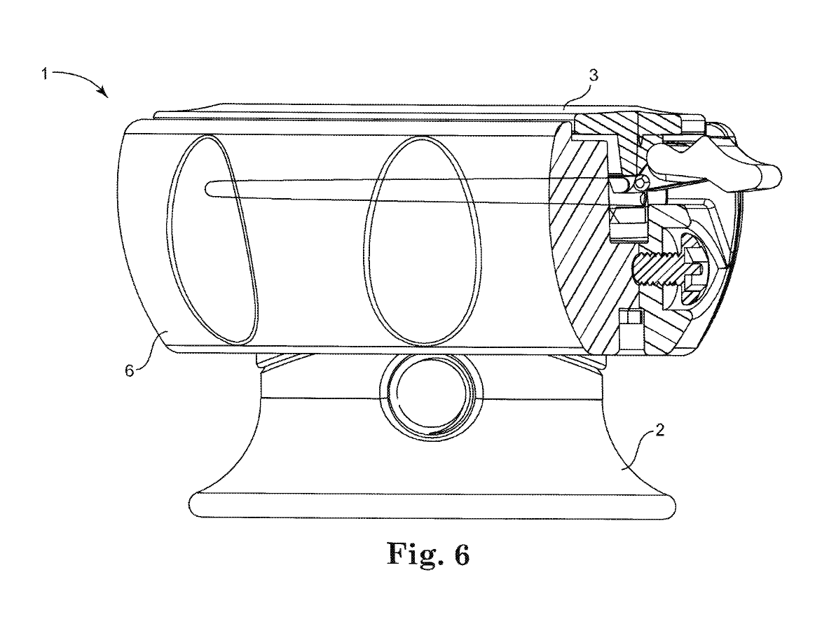

FIGS. 3-6 are cutaway drawings of the assembled quick release mechanism 1 of FIGS. 1 and 2.

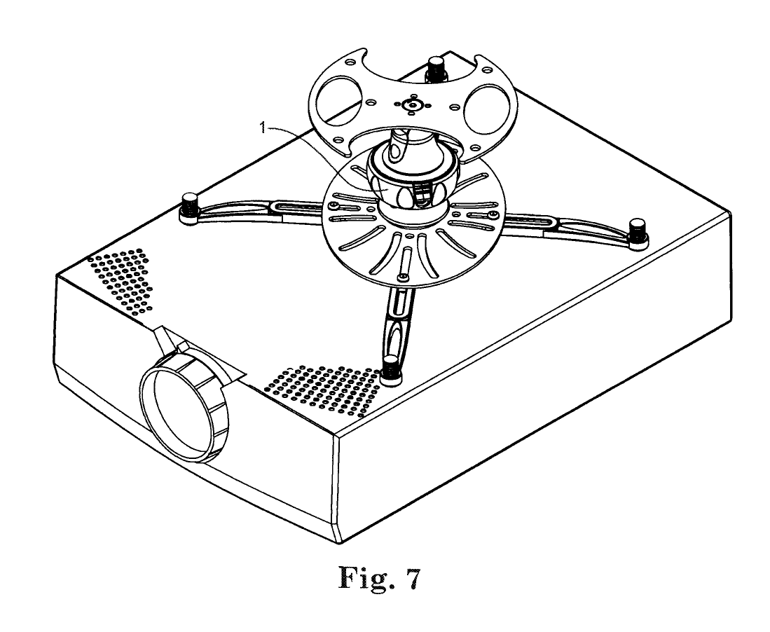

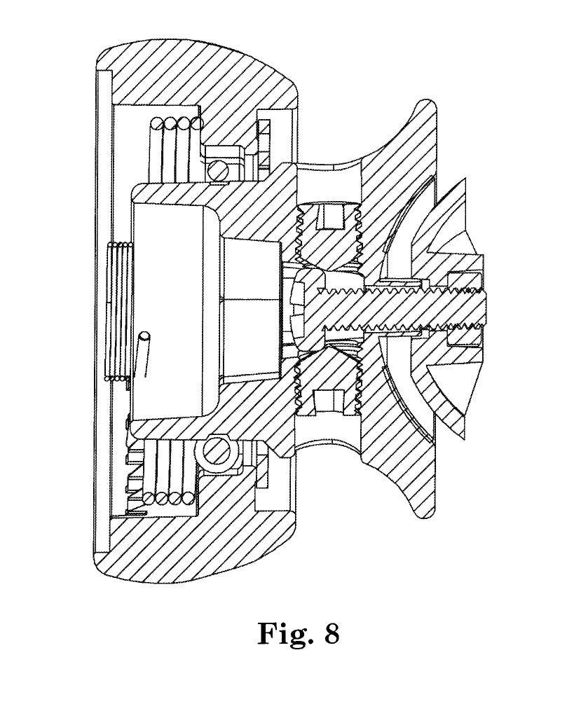

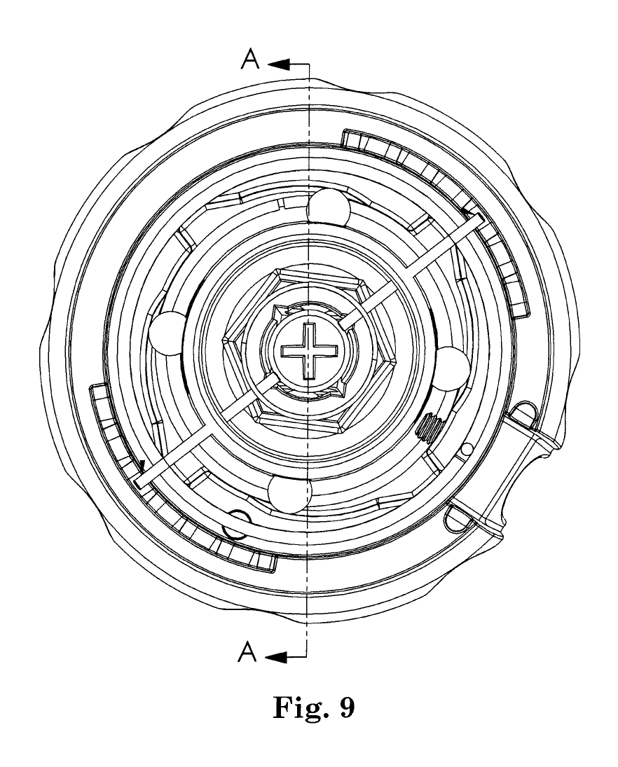

FIGS. 8 and 9 illustrate some of the operation of the disclosed device. Looking at FIG. 8, pins 4A and 4B extend radially from the center threaded portion 38 thru passages 120 (see FIG. 2). The pins are biased upwardly at their distal ends 140 by the placement of a resilient member o-ring/grommet) 110 under the proximal end of the pins adjacent 38. This occurs because the end of the pins 4 proximal to hole 38 reside in recesses 112 and are pivoted upwardly at their distal ends by the bias force of ring 110 which urges those ends upwardly. Distal ends 140 then engage teeth 63 in a ratchet fashion, so that rotation of the twist collar 6 is inhibited. This is the ‘cocked’ position. The insertion of spindle swivel 2. The distal edge of swivel 2, when inserted into collar assembly 6 will depress pins 4, which will release teeth 63. At that time, the collar 63 is free to rotate and indeed is urged to by spring 7. This causes ramps 62A/B to drive balls 5 (ABCD) into engagement with spindle swivel notches 22. With the balls driven into the notches, the two parts of the mount are securely locked together. The additional latch 9 may also we used as well as a set screw on ring 64 (not shown) if desired.

It is noteworthy, that in the preferred embodiment, the locking of the assembly is visually apparent by the rapid twisting/rotation of ring 64 in response to spring force. It is also generally audible as the balls may snap into their respective notches. This makes it easy for a user to know that the system is securely locked.

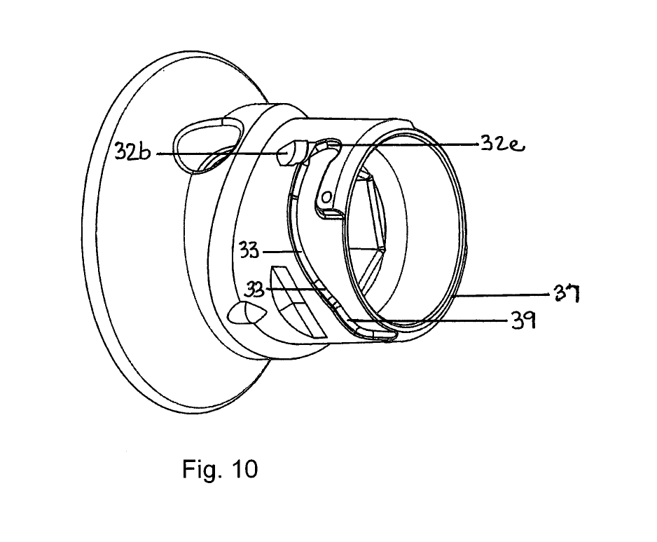

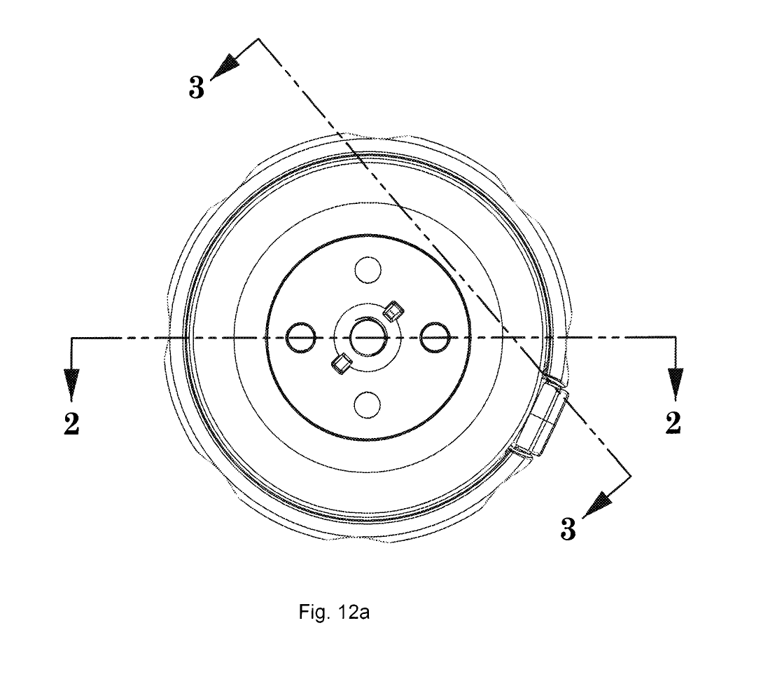

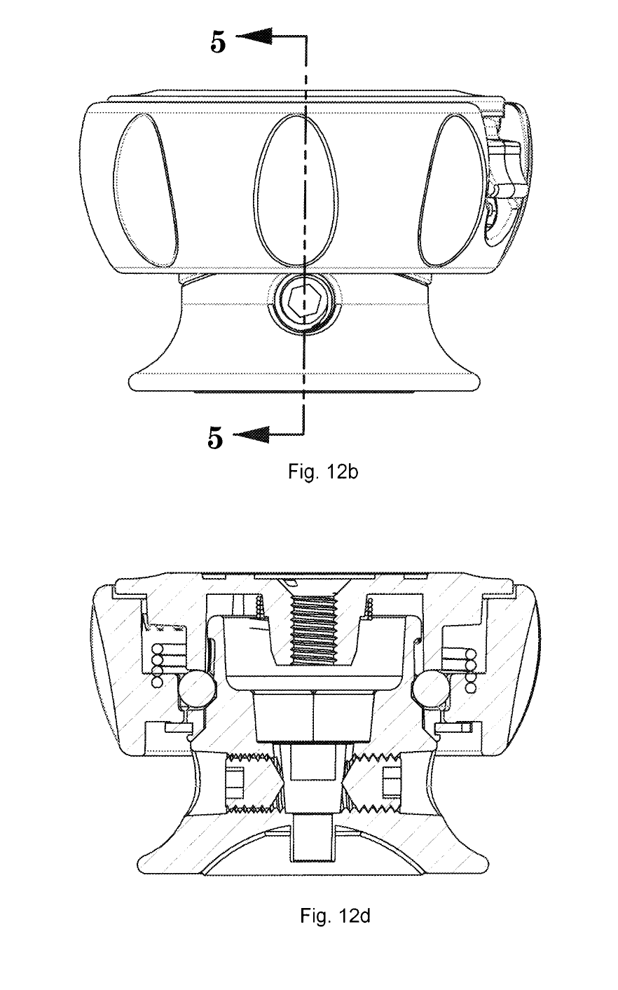

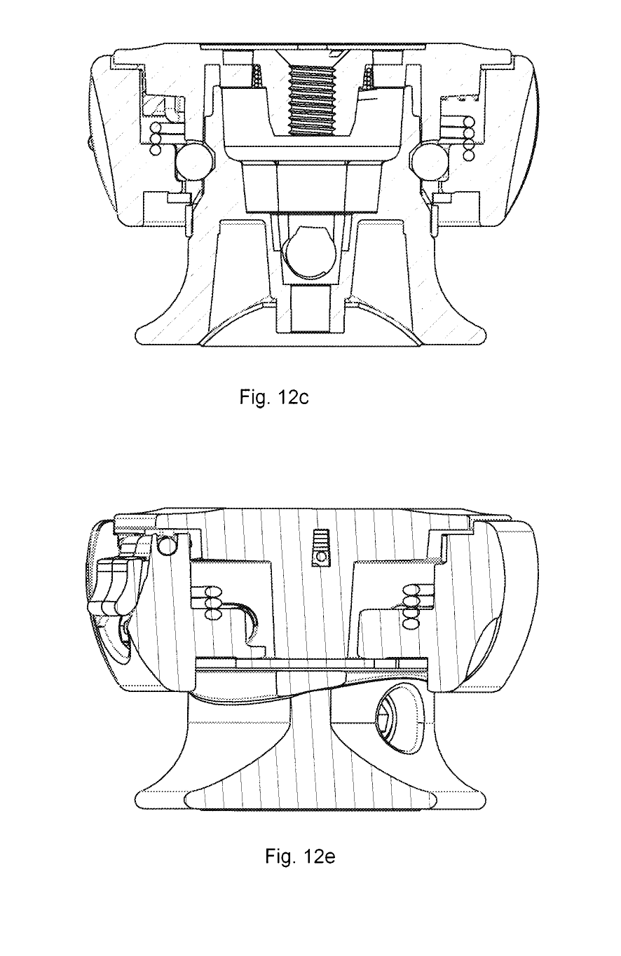

FIGS. 10-12 illustrate a new feature which provides safety benefits.

In the first embodiments above, once collar 6 has been rotated and safety lock tab 9 has been removed, the projector is free to be removed. Thus it is possible for the installer to drop it. To solve this problem a additional safety features have been added. For example the release track/channel may include ledge/shelf toward the end thereof. When the collar is twisted the spindle will drop but is prevented from final removal by engagement of at least one of the balls 5 in the shelf edge after the ball was released. Note that it would be possible to achieve this result with projections which are not necessarily balls. Indeed, the projections may be in two varieties, retractable/releasable and non-retractable/releaseable. The retractable projections allow for the first level of release which allows the spindle and receiver to be released but not separated. The non-retractable projections form part of the safety system which must follow a channel exit path by twisting of the two parts. Finally, there may be a plurality of stops which force or overcenter force to move the projections out of their channels.

Unlike the embodiment in FIGS. 1-9, where twisting of collar 6 releases balls 5a-c simultaneously, in this safety version, at least one and preferably two of the balls 5 are not released. For example balls 5A and 5C may be released while 5B and 5D may be retained outwardly biased in apertures 32.

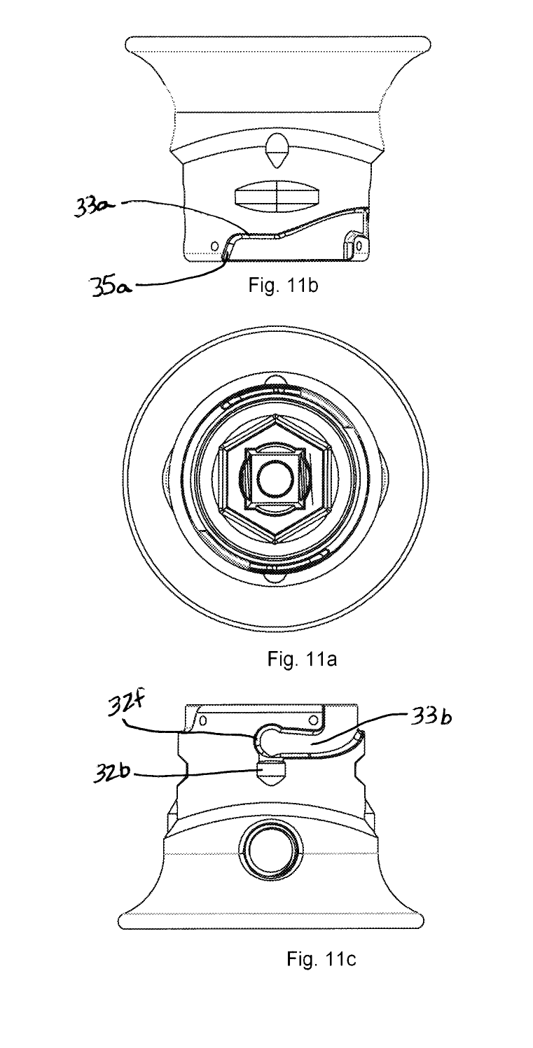

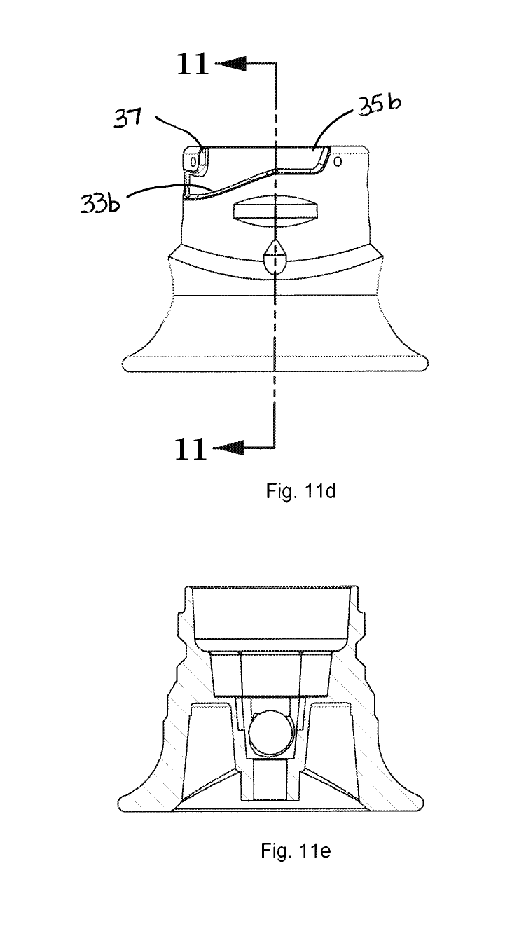

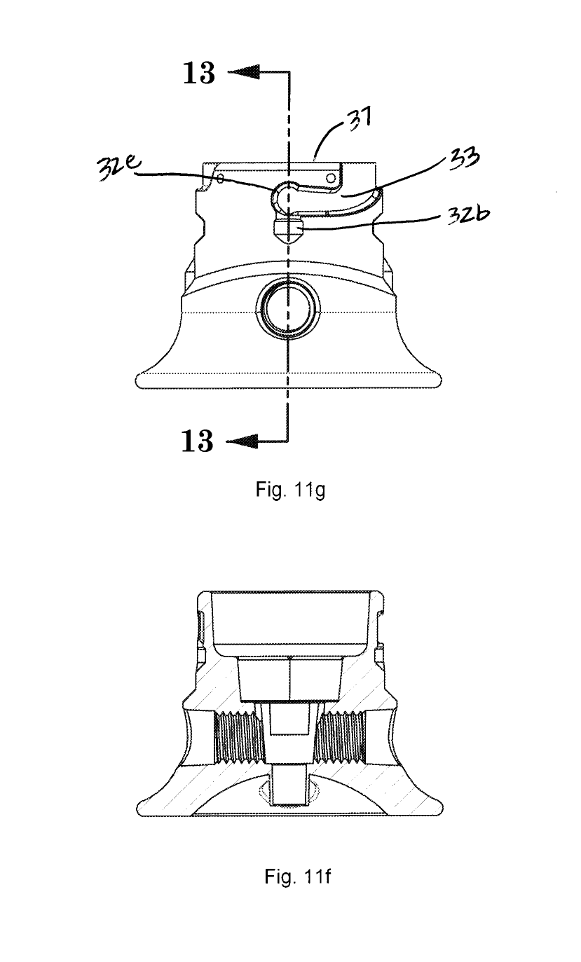

When two of the balls that are released (ie free to be retracted out of engagement with slots 22A-C or 22B-D in the spindle 2), the remaining balls which remain outwardly biases remain engaged in their receiver holes or depressions 32. In this embodiment two of the engagement slots are connected to a further slot regions 32E and 32F as shown in FIGS. 11c and 11g.

Slot regions 32E and 32F are preferably located above (ie toward the end of spindle insertion into the collar potion) and formed with radiussed portions to receive a portion of the ball 5 to keep the spindle 2 in a static state, released from rigid engagement with the collar portion, but still not removable from therefrom. Note that the preferred radiussed portion is above the channel 33 (or the channel is below the radiussed portion to create a stop or shelf or holding zone, which gives the user a chance to prepare for separation of the two parts. For final separation of the portions, further rotation of the spindle relative to the collar portion is necessary as will be explained. It may require over center twisting force to move the projections out of the radiussed area and into the lower channel.

A release passage 33A and 32B are attached to slot regions 32E-F and follow a circumferential passage around roughly 90 degrees of rotation to an exit slot 35A-35B which terminates at the peripheral edge of the spindle.

Therefore, it can been seen that, after rotation of the collar 6, two opposing balls of the collar are released but two are not. The spindle (and projector) can drop downward a short distance so that the balls 5 can pass, under the force of gravity from recesses/slots 32B (for example) to adjacent connected recesses 32E-F where the spindle will hang suspended. The user must then proactively rotate the spindle, so that the protruding balls 5 follow the circumferential passages 33A-B until the balls 5 can fully exit the spindle at the exit 35A-B.

The circumferential passage 33A-B preferably follows a helical path which approached the distal edge 37 of the spindle. Helical means generally following an upward path toward the peripheral edge, which may be a helix, spiral or other curved path. In the embodiment shown, most clearly in FIG. 10, passage 33A-B starts at channel/recess 32, but below the uppermost extent of the recess (this creates a “stop point” or lip in the spindle channel, effectively a detent function, so that it does not immediately enter the preferable helical passage/channel 33). As shown in FIG. 10, the passage channel 33 is generally helical until it reaches a plateau—generally flat landing zone/stop portion 39 which also prevents/delays the complete separation of the spindle from the collar portion. In the landing zone the spindle has no turning moment, ie it is not urged to turn toward final release of the spindle from the spindle receiver. This allows the user one more chance to prepare for separation of the two parts.

This disclosure also includes a method to prevent unexpected separation of interlocking parts, by the steps of releasing a first part from a second part to allow limited but not complete separation, holding the two parts engaged on ledge portion, twisting the two portions relative to each other to overcome resistance against rotation, continuing the rotations along a channel which permits complete separation of the parts.

The resistance step can include overcoming a detent. It can also be an offset between the stop point and the connected channel which requires the spindle to be raised slightly to allow entry into the channel

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. In a quick release mechanism for a hanging projector mount, comprising:
a spindle comprising:
a generally cylindrical male mating surface having outer diameter and including a plurality of spindle recesses and a distal peripheral edge;
a spindle receiver for receiving the spindle, the spindle receiver comprising:
a generally cylindrical female mating surface sized to accommodate the male mating surface and including a plurality of spindle receiver holes; and
wherein when the spindle is fully inserted into the spindle receiver, the spindle receiver holes are aligned with the spindle recesses;
a plurality of balls sized smaller than the spindle receiver holes for engaging the spindle swivel recesses;
the safety feature improvement comprising:
a lock pivotally attached to the spindle receiver and rotatable from a locked position to an unlocked position, having a collar, which causes some, but not all, of the balls to disengage from said recesses, said remaining balls remaining non-retracted from said recesses,
a channel connected to and leading from said recesses which have non-retractable balls engaged therein, said channel running from said recesses to said distal peripheral edge of the spindle thereby creating a path for said non-retracted balls follow to achieve complete disengagement of the spindle from said spindle receiver.

2. The improvement to the quick release mechanism of claim 1, wherein the said at recess includes a landing recess directly adjacent thereto, said stop recess including a radiussed upper portion to receive a portion of the ball.

3. The improvement to a quick release mechanism of claim 2, wherein said channel abuts said stop recess below said radiused portion.

4. The improvement to a quick release mechanism of claim 3 wherein said channel includes a helical portion.

5. The improvement of claim 4 wherein the channel includes a landing zone between the peripherical edge and the recess.

6. The improvement to a quick release mechanism of claim 4, wherein channel includes a helical portion connected to said landing recess at a proximal end and a generally flat portion extending from a distal portion of said channel.

7. A safety feature on a twist release mechanism having a spindle with a distal peripheral edge, a spindle receiver sized to receive said spindle, at least one retractable projection in said receiver and at least one non-retractable projections in said spindle receiver, said projections being receivable into recesses in said receiver, said retractable projects being retractable in response to a release mechanism; the safety feature comprising:
a channel connected to and leading from said recesses associated with said at least one non-retractable projection, said channel running from said recesses to said distal peripheral edge of the spindle thereby creating a path for said non-retracted balls follow to achieve complete disengagement of the spindle from said spindle receiver, said channel following a generally helical path to said distal edge and including a landing zone region which is generally flat where said projections with have no turning moment.

8. A method of preventing accidental removal of a two part cylindrical coupling being held together by engagement of projections in one part projecting into recesses in the other part, at least some of the recesses being in communication with channels extending to a distal edge of part on which the channels are located, comprising the steps of:
a. releasing at least some, but not all of the projections from their recesses to allow limited but not complete separation,
b. maintaining the two parts engaged at on a portion of the channel,
c. twisting the two portions relative to each other to move the projections in the recesses along the channel,
d. continuing the rotations along a channel until the projections reach the peripheral edge and thus complete separation of the parts.

9. The method of claim 8 further including the step twisting one part thru a landing zone area of no turning moment.

10. The method of claim 8 further including the step of twisting one part thru a stop zone which resists twisting.
